(19) United States
(12) Patent Application Publication
(10) Pub. No.: US 2004/0267672 A1
(43) Pub. Date: Dec. 30, 2004

(54) System and method for conducting secure electronic transactions

(76) Inventors: William J. Gray, Salt Lake City, UT (US); Gerald W. Smith, Ruther Glen, VA (US); Carl J. Larkin, Brighton (GB); Lee J. Peart, England (GB); Peter D. Saunders, Salt Lake City, UT (US); Stuart Fiske, Surrey (GB); Darren N. Morford, (US)

Correspondence Address: Stephen T. Scherrer, McDermott, Will & Emery, 227 West Monroe, Chicago, IL, 60606-5096, US

(21) Appl. No.: 10/607,144

(22) Filed: Jun. 26, 2003

(51) Int. Cl. G06F 17/60

(52) U.S. Cl. 705/65

(57) ABSTRACT

A system and method for conducting secure electronic transactions are provided. More specifically, a system and method are provided for conducting secure transactions utilizing tokens, such as transaction cards, such as credit cards or the like, on a computer. The computer is token-enabled, having a token reader and software in communication with itself allowing the token user to communicate with a goods and/or services provider that supports a secure on-line transaction. Moreover, a system and a method are provided for conducting secure transactions on-line with a token having a microchip embedded therein for additional security.

### FIELD OF THE INVENTION

The present invention relates to a system and method for conducting secure electronic transactions. More specifically, the present invention relates to a system and a method for conducting secure transactions utilizing smart tokens on a computer. The computer is token enabled, having a token reader and software in communication with itself allowing the user to communicate with an entity that supports a secure on-line transaction. Moreover, the present invention relates to a system and a method for conducting secure transactions on-line with a token having a microchip embedded therein for additional security.

### BACKGROUND OF THE INVENTION

It is, of course, generally known to utilize transaction cards, such as credit cards or other like transaction tokens, for the purchase of goods and/or services. Many goods and/or services providers that sell products allow for the capability for the purchase of goods and/or services utilizing tokens. Typical transaction tokens, such as transaction cards, have alpha-numeric information stored on the cards via a magnetic stripe that is disposed on a surface of the transaction. The magnetic stripe can be read via a magnetic stripe reader, and can include information relating to, for example, a unique identifier, an account number and the like.

Due to the susceptibility of the magnetic stripe to tampering, the lack of confidentiality of the information within the magnetic stripe and the problems associated with the transmission of data to a host computer, integrated circuits were developed which could be incorporated into transaction cards or tokens. These integrated circuit (IC) cards or tokens, known as smart cards or smart tokens, proved to be very reliable in a variety of industries due to their advanced security and flexibility for future applications.

The use of smart tokens with token readers are typically used only in physical point-of-sale transactions. In other words, “brick and mortar” goods and/or services providers typically carry the equipment, the means, and the ability to conduct token transactions in the physical world. Specifically, use of tokens requires the utilization of token readers, which may be utilized by goods and/or services providers, to allow a goods and/or services provider to communicate with a token authenticator for approving a transaction involving the token, which can include authenticating said token. Intelligent tokens, i.e., tokens having microchips embedded therein, provide token issuers and their designees with the ability to authenticate the token, authenticate the token user, and analyze the purchase history of the token user. These benefits of utilizing smart tokens with token readers at goods and/or services providers for the purchase of goods and/or services have not typically been available for the purchase of goods and/or services on-line on the internet or other like network.

However, the internet has rapidly become one of the main resources for buyers and sellers to exchange their goods and/or services. In fact, some goods and/or services providers have no physical presence in the sense of a “brick and mortar” building for their merchandise, but conduct all of their sales on the internet. For example, Amazon.com has no physical presence in the real world, in terms of a “brick and mortar” establishment. They conduct most, if not all, of their merchandise sales on the internet. In addition, many other businesses conduct at least a portion of their sales via the internet.

The rise of the internet as a successful outlet for selling and purchasing of goods and/or services has been accompanied by many fraudulent uses of tokens. Specifically, many virtual sellers of goods and/or services require merely the input of a token number and minimal information. Individuals who wish to fraudulently utilize tokens must merely input a stolen token number and other minimal information to get goods and/or services from the internet. This other minimal information may be relatively easy to obtain, such as via theft of the information by, for example, hacking into a database and stealing the information relating to the token number and utilizing this information to fraudulently verify the identity related to the token. In fact, identity theft by stealing token numbers and information is a growing problem, and the internet makes it relatively easy to accomplish.

One solution to providing increased security for transactions on the internet using tokens is to require the manual input of the token number, expiration date and a security code. Additionally, other information may be entered as well, including address information, a ZIP code, phone number or PIN. The extra information that must be entered during a transaction on the internet provides a measure of security, but is still insecure in the sense that an individual who wishes to fraudulently utilize a token may somehow obtain the extra information. For example, an individual who wishes to fraudulently utilize a token that has been stolen may merely be required to enter information that may also be stolen, or otherwise readily available, such as address, phone number or ZIP code information.

In addition, security codes that are utilized to provide security for on-line transactions typically require that the security code be changed periodically, which requires an amount of communication between the token authenticator and the token user. Therefore, infrastructure must be developed to provide security codes to the token users on a regular basis. Moreover, token issuers and their designees may allow token users to choose their own security codes, which should also be changed periodically. Infrastructure is necessary for this system as well, such as means to communicate the security codes to the user, or to provide a method for the user to input his or her own security codes.

However, requiring security codes to be entered, as well as token numbers and expiration dates, is typically processed by a token issuer as a “card not present” transaction and therefore does not allow for the authentication of the token and the token user in a reliable way. Moreover, requiring security codes does not allow for the tracking of historical purchasing information, such as information that may be analyzed to determine if the token is being fraudulently used.

A need, therefore, exists for a system and a method for conducting transactions over the internet that are secure. More specifically, a need exists for a system and a method for conducting secure transactions over the internet wherein the transaction is conducted as a “card is present” transaction and further is conducted without the use of security codes and the like that typically cannot be utilized in a reliable way. Further, a need exists for a system and a method that allows for the tracking of historical purchasing information when conducting purchases over the Internet.

### SUMMARY OF THE INVENTION

The present invention relates to a system and method for conducting secure electronic transactions. More specifically, the present invention relates to a system and a method for conducting transactions utilizing tokens, such as intelligent tokens, i.e. having a microchip embedded therein, for the purchase of goods and/or services on-line on the internet, or other like network, wherein the intelligent token is processed by the token authenticator as a “card is present” transaction. In addition, the present invention relates to a system and a method for conducting secure transactions on-line using tokens having integrated microchips contained therein. The intelligent tokens are utilized in the “virtual” world, in that transactions may be conducted on-line over the internet from a computer, or other like device, by physically using the token reader that is in communication with a computer. The token reader allows a transaction to be conducted on-line on the internet, or other like network, having the same capabilities as a card transaction at a physical “brick-and-mortar” merchant, with the same advantages attached thereto.

It is, therefore, an advantage of the present invention to provide a system and a method for conducting transactions on-line on a network, such as the internet, or other like network. Moreover, it is an advantage of the present invention to provide a system and a method for conducting secure transactions on the internet whereby the token and the token user can be authenticated, thereby minimizing the risk that an individual will fraudulently utilize the token.

In addition, it is an advantage of the present invention to provide a system and a method for conducting secure transactions on the internet utilizing a token via a token reader in communication with a computer that is in communication with the internet. Moreover, it is advantage of the present invention to provide a system and a method for conducting secure transaction over the internet utilizing a token having an embedded microchip for providing additional security for the transaction.

Still further, it is an advantage of the present invention to provide a system and a method for conducting secure transactions over the internet utilizing a token whereby the token must be physically present. In addition, it is an advantage of the present invention to provide a system and a method for conducting secure transactions over the internet utilizing a token whereupon the token or the identification of the user can be authenticated. Still further, it is an advantage of the present invention to provide a system and a method for conducting secure transactions over the Internet whereupon the relation of the transaction can be verified with respect to the historical transaction behavior of the user.

And, it is an advantage of the present invention to provide a system and a method for conducting secure transactions over the Internet by utilizing a token via a token reader that is in communication with a computer such that authentication and authorization is accomplished using existing infrastructures or other like infrastructures.

In addition, it is an advantage of the present invention to provide a system and a method for conducting secure transactions over the internet that can be utilized by any token issuer or its designee. In addition, it is an advantage of the present invention to provide a system and a method for conducting secure transactions over the internet that provides cost savings for goods and/or services providers because of the reduction in risk that the transaction may be fraudulent.

In addition, it is an advantage of the present invention to provide a system and a method for conducting secure transactions over the internet by using an already established internationally-approved payment standard. In addition, other payment standards are contemplated in the present invention, and this invention should not be limited as herein described. Further, other transaction standards may be utilized besides payment standards.

Further, it is an advantage of the present invention to provide a system and a method for conducting secure transaction over the Internet that is simpler to use, using minimal hardware and software in communication with a computer having access to the Internet and is further easily integrated with goods and/or services providers.

Additional features and advantages of the present invention are described in, and will be apparent from, the detailed description of the presently preferred embodiments and from the figure.

### BRIEF DESCRIPTION OF THE DRAWINGS

FIG. 1 illustrates a schematic of a system of the present invention including a computer for conducting secure transactions via the internet using an attached token reader.

### DETAILED DESCRIPTION OF THE PRESENTLY PREFERRED EMBODIMENTS

The present invention relates to a system and method for conducting secure electronic transactions. More specifically, the present invention relates to a system and a method for conducting transactions utilizing tokens having embedded microchips contained therein (so-called “intelligent tokens”) on a computer network such as the internet. The smart cards are utilized in the “virtual” world, in that transactions may be conducted on-line over the internet from a computer, or other like device, by physically using the intelligent token. A transaction conducted over the internet may be facilitated via the use of a token reader that is in communication with a computer. The token reader allows a transaction to be conducted on-line on the internet, or other like network, having the same capabilities as a card transaction at a physical “brick-and-mortar” goods and/or services provider, with the same advantages attached thereto.

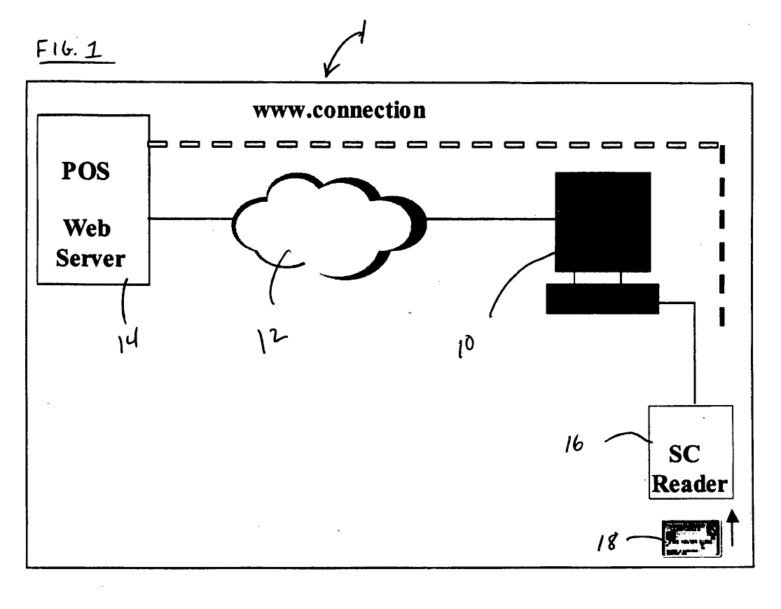

Now referring to the figures, wherein like numerals refer to like parts, a system 1 for conducting virtual transactions for the purchase of goods and/or services via a network, such as the internet, is shown in FIG. 1. In general, a processor means 10, such as a computer, a network-enabled telephone, a personal digital assistant, or the like, that is interconnected to the network 12 may be utilized to purchase goods and/or services via the Network 12 from a good or service provider's web server 14, constituting a virtual point-of-sale. The processor means 10 may further be in communication with a token reader 16. For example, the token reader 16 may be in communication with the processor means via a cable, such as a USB cable, or any other cable. Alternatively, the token reader 16 may be in communication with the processor means 10 via a wireless connection, such as an infrared connection or the like.

The token reader 16 may be utilized by an individual when purchasing goods and/or services from the network 12 at the goods and/or services provider's web server 14 by initiating communication between a token 18 and a corresponding token reader 16. For example, the token 18 may be “swiped” through the token reader 16 so that the token reader 16 may read the information on the token 16. Initiating communication from the token 18 may include physically moving the token along a slot, thereby physically inputting the token into a slot. A token in the form of a transaction card may be suitable for swiping. Of course, any other method of reading the token 18 by the token reader 16 is contemplated by the present invention, such as bringing the token within range of the token reader by which radio, infrared, electromagnetic, optical, microwave, and various transmission mechanisms may be utilized for reading information contained on the token 18.

Specifically, the token 18 may be an “intelligent token”, whereby a microchip is embedded within the token 18 providing for secure transactions when the token is utilized. The microchip may contain information such as a unique token identifier that may be the same as represented on the face of the token (typically embossed on the token) or a virtual identifier, which is a different number than the number provided on the face of the token, thereby providing an increased level of security. Other information that may be contained within the microchip may be credit limit information, PIN information, PIN retry counters, transaction historical information, status information, biometric information, and the like. Moreover, the microchip contained within the token 18 may be readable by a token reader. Therefore, the token reader 16 is preferably a smart card reader, whereupon the information contained on the microchip within the smart card can be accessed and retrieved by the smart card reader.

A customer who wishes to purchase goods and/or services from a goods and/or services provider via the network, such as the internet, may access the goods and/or services provider's website via the goods and/or services provider's web server 14 using the processor means 10. When the customer has decided on particular goods and/or services to purchase, by indicating to the goods and/or services provider's web site that the customer would like to “check out”, the goods and/or services provider's web site automatically surveys the processor means 10 to determine whether the processor means 10 can support an on-line transaction utilizing a token reader 16. Typically, the processor means 10 can have a cookie, or some other designation on the processor means, that identifies to a goods and/or services provider that the processor means is capable of supporting an on-line transaction utilizing the token reader 16. If the processor means 10 can support an on-line transaction utilizing a token reader 16, then the goods and/or services provider can offer this payment option to the customer and the customer can choose it. Alternatively, the customer may choose this payment option from a list of payment options on the goods and/or services provider's website without the merchant scanning the processor means 10 for an indication whether the processor means 10 can support on-line transactions utilizing a token reader 16.

The goods and/or services provider's web server 14 connects to the token issuer or their designee (not shown) whereupon the goods and/or services provider's web server 14 passes details about the particular transaction between the processor means 10 and the goods and/or services provider's web server 14. Typically, the token issuer or its designee acts as an authenticator of the token and/or an approver of the transaction. The details that are passed about the transaction may include, for example, a unique transaction identifier. The goods and/or services provider's web server 14 then invokes token authenticator software on the processor means 10 to facilitate a secure connection between the processor means 10 and the token authenticator. The goods and/or services provider's web server 14 passes information (such as the unique identifier) to the software on the processor means 10. The software then connects the processor means 10 to the token authenticator via a secure connection over the network. The software then passes the information (such as the unique identifier) supplied by the goods and/or services provider's web server 14 to the token authenticator thereby establishing a secure connection between the processor means 10 and the token authenticator. The processor means 10 may then display a notice (such as “Processing Transaction”) to the customer indicating that the transaction is being processed between the processor means 10 and the token authenticator.

The processor means 10 may then request that the token 18, preferably an intelligent token, be inserted, swipe, or brought within range of the token reader 16. The token authenticator may then receive the information read from the token 18 via the token reader 16 and verify the authenticity of the token 18. For example, the token authenticator may send the information to an authentication system (such as a Card Authorization System (CAS)) for authenticating the token 18. Because the information contained on an intelligent token can be more detailed and uniquely tailored to a customer as compared to a traditional token, a intelligent token can be utilized to more positively authenticate a customer than a traditional token. In addition, when the token authenticator is authenticating the token, or after the token has been authenticated, the token authenticator may update the token with transaction information or any other information.

When the authentication system (such as CAS) has authenticated the token 18 that has been scanned, swiped or otherwise read by the token reader 16 and if the token authenticator approves the transaction, the token authenticator, may inform the goods and/or services provider's web server 14 that the transaction is either approved or disapproved, depending on whether the token is authenticated, or for any other reason. If the token 18 is not authenticated by the authorization system (such as CAS) or if the transaction is otherwise not approved, the token authenticator may inform the goods and/or services provider's web server 14 of this fact. In addition, the token authenticator may inform the processor means 10 of the authentication status (i.e. whether the transaction was successful or not). The processor means 10 may then display a message to the customer. If the transaction was successful, then a notice (such as “Transaction Complete”) may be displayed by the processor means 10 to the customer.

After the token authenticator has approved the transaction and has informed both the goods and/or services provider's web server 14 and the processor means 10, the token authenticator may redirect the processor means back to the goods and/or services provider's web server 14 to obtain the results of the transaction. The goods and/or services provider's web server 14 may then inform the processor means 10 whether the transaction was successful. Alternatively, the token authenticator can inform the customer whether the transaction is successful.

The token reader 16 is preferably, as noted above, a smart card reader that allows a smart card, i.e. a flat token having a microchip therein containing data and/or applications for securely transferring information or providing authentication means to the token issuer. Specifically, the information contained on the token may be transmitted to a goods and/or services provider over the network in a secure fashion and further allows the token issuer to challenge the token as to its authenticity. In addition, the token allows the token authenticator to act upon the transaction based on the card member's and token's transaction history. Moreover, the token authenticator may update the token with information such as new credit limits, PIN retry counters, transaction history information, status information and the like, all of which may be used in the authorization of future transactions.

Alternatively, the token reader 16 may itself contain a token that is permanently disposed within the token reader 16. Specifically, the token contained in the token reader 16 may contain information, data, and the like, and may further contain an application or applications that is/are resident in the Read Only Memory of the token. The application(s) may contain the security and instructions necessary to uniquely identify that token to the token authenticator such that the token contained within the token reader 16 may be challenged by the token authenticator, or other entity to determine the authenticity of the token within the token reader 16. In addition, the smart card contained within the token reader 16 may be combined with the card member's token that is scanned, swiped, inserted, brought into range of or otherwise in contact to the token reader 16, which can then be challenged by the token authenticator or other like entity to determine both the authenticity of the customer's token and the authenticity of the token contained within the token reader 16. In addition, the token inside the token reader 16 may be able to challenge the authenticity of the token that may be in contact with the token reader 16.

Alternatively, the token reader 16 may contain a “virtual” token, i.e., an intelligent token that is not physically present, but is contained within the token reader 16. The virtual token inside the token reader 16 may perform the same functions as the physical token disposed within the token reader 16 as described above.

The present invention may include various methods and systems for providing increased security when utilizing the token in the token reader 16 of the present invention. For example, the card member's token and the token reader 16 may be mutually authenticated. Specifically, this allows not only the token to be authenticated, but the token reader 16 as well. This may help to prevent man-in-the-middle attacks, denial of service attacks, and similar negative consumer experiences or fraud opportunities.

In addition, the intelligent token may have data and logic sequences that prevent the cloning of the intelligent token. Moreover, cryptographic algorithms may be utilized that may be highly tamper-resistant. For example, probing and attack methods such as simple and differential power analysis, differential fault analysis, logic probing, and other such intrusive and non-intrusive methods may be utilized to obtain data that is not protected by use of sufficiently strong cryptographic algorithms. Moreover, other methods and systems of providing secure transactions and authenticating the card member's tokens and/or token readers may be utilized in the present invention.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A system for conducting secure transactions comprising:
a processor means in communication with a network;
a goods and/or services provider in communication with the network;
a token reader in communication with the processing means;
a token having transaction account information stored thereon wherein said token is read by the token reader when conducting a transaction with the goods and/or services provider via the network.

2. The system of claim 1 wherein said network is the internet.

3. The system of claim 1 wherein said processing means is a computer.

4. The system of claim 1 wherein said processing means is a telephone.

5. The system of claim 1 wherein said processing means is a personal digital assistant.

6. The system of claim 1 wherein said token comprises an integrated microchip for storing information thereon.

7. The system of claim 1 wherein said token reader reads said transaction account information from said token.

8. The system of claim 7 wherein said token reader reads said information from said token by scanning said token.

9. The system of claim 1 further comprising:
an authorization system in communication with the network for authenticating the transaction with the goods and/or services provider.

10. The system of claim 1 wherein said goods and/or services provider has a web-site for conducting transactions via the network.

11. The system of claim 1 wherein said processing means comprises an identifier that indicates to the goods and/or services provider whether the processing means is enabled to conduct transactions with a token reader.

12. A method of conducting secure transactions comprising the steps of:
providing a customer having a processor means in communication with a network and further in communication with a token reader;
providing a goods and/or services provider in communication with the network;
the customer contacting said goods and/or services provider with the processor means via the network and selecting a good and/or service to purchase, said customer utilizing a token for the purchase of said good and/or service;
the goods and/or services provider communicating with a token authenticator via the network for enabling an authentication of the customer's token;
the processor means obtaining transaction account information from said token with said token reader;
the processor means passing said transaction account information to said token authenticator via the network for authenticating said token; and
the token authenticator approving the transaction if the token authenticator authenticates the token.

13. The method of claim 12 wherein said network is the internet.

14. The method of claim 12 further comprising the step of:
the goods and/or services provider detecting whether the processor means is able to support a transaction using a token reader after the customer selects a good and/or service for purchase from the goods and/or services provider.

15. The method of claim 12 further comprising the step of:
the goods and/or services provider offering to said customer an option of conducting the transaction with the token reader after the customer selects a good and/or service for purchase from the goods and/or services provider.

16. The method of claim 15 further comprising the step of:
the customer selecting the option to conduct said transaction with the token reader.

17. The method of claim 12 further comprising the step of:
the goods and/or services provider passing transaction details to both said token authenticator and said processor means via the network after the customer selects a good and/or service for purchase from the goods and/or services provider.

18. The method of claim 17 further comprising the step of:
the processor means communicating with said token authenticator for authenticating the transaction by passing the transaction details to said token authenticator after the goods and/or services provider passes said transaction details to said processor means.

19. The method of claim 12 further comprising the step of:
the goods and/or services provider invoking software for utilizing said token reader in communication with said processor means via the network after the customer selects a good and/or service for purchase from the goods and/or services provider.

20. The method of claim 12 further comprising the step of:
the processor means obtaining the transaction account information by scanning the token with the token reader.

21. The method of claim 12 further comprising the step of:
communicating to said customer that the transaction is processing after the processor means passes said transaction account information to said token authenticator.

22. The method of claim 21 wherein said token authenticator communicates to said customer that the transaction is processing.

23. The method of claim 12 further comprising the step of:
the token authenticator communicating to the goods and/or services provider via the network whether the transaction is approved or not.

24. The method of claim 12 further comprising the step of:
communicating to the customer that the transaction is complete via the network after the token authenticator approves or disapproves said transaction.

25. The method of claim 12 further comprising the step of:
the token authenticator redirecting the customer back to the goods and/or services provider on the network.

26. The method of claim 12 further comprising the step of:
the customer obtaining the results of whether the transaction is approved via a communication from the goods and/or services provider on the network.

27. The method of claim 12 wherein said token reader is capable of scanning an intelligent token.

28. The method of claim 12 wherein said token reader is capable of scanning a transaction card.

29. The method of claim 28 wherein said transaction card is a smart card.
